(19) United States
(12) Patent Application Publication
(10) Pub. No.: US 2010/0287174 A1
(43) Pub. Date: Nov. 11, 2010

(54) IDENTIFYING A LEVEL OF DESIRABILITY OF HYPERLINKED INFORMATION OR OTHER USER SELECTABLE INFORMATION

(75) Inventors: I-Hsuan Yang, Sunnyvale, CA (US); Yen-Yu Chen, Santa Clara, CA (US); Keeyong Han, San Jose, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/463,808

(22) Filed: May 11, 2009

(51) Int. Cl. G06F 17/30; G06N 5/02; G06N 5/04; G06F 15/18

(52) U.S. Cl. 707/759; 706/54; 706/52; 706/12; 706/46

(57) ABSTRACT

Embodiments of methods, apparatuses, or systems relating to identifying a level of desirability of a hyperlink or search query using experience score.

### BACKGROUND

1. Field

The subject matter disclosed herein relates to identifying a level of desirability of at least a portion of a hyperlinked file or otherwise user-selectable information.

2. Information

Finding information stored or existing in digital form, such as in the form of binary digital signals, may sometimes be a time-consuming and potentially perilous undertaking. For example, finding information on the Internet, such as by selecting a hyperlink as presented on a web page, or by inputting a search query into an online search field, may result in a user occasionally being presented with hyperlinks associated with files that may be irrelevant, offensive, or which may no longer exist. Similarly, a user may have a somewhat similar finding while searching for information in offline computer applications, such as, for example, by entering a search query into a desktop search application or by accessing a hyperlink presented in an offline document application. Thus, with so much information existing and reposed in digital form, there may be a desire to at least identify information which a user may deem to be desirable or undesirable in a more efficient or cost effective manner.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a schematic diagram illustrating a version of a displayed web page with exemplary operatively selectable hyperlinks and an exemplary search query field in accordance with an embodiment.

FIG. 2 is a flow chart depicting an embodiment of a method to identify a level of desirability of a hyperlinked file or other user selectable information, such as a proposed search query.

FIG. 3 is a schematic diagram depicting an embodiment of an exemplary apparatus to identify or estimate a level of desirability of a hyperlinked file or other user selectable information, such as a proposed search query.

FIG. 4 is a schematic diagram depicting an embodiment of an exemplary system to identify or estimate a level of desirability of a hyperlinked file or other user selectable information, such as a proposed search query.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some portions of the detailed description which follow are presented in terms of algorithms or symbolic representations of operations on binary digital signals which may be stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

The terms, “and,” “and/or,” and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. Reference throughout this specification to “one embodiment” or “an embodiment” or a “certain embodiment” means that a particular feature, structure, or characteristic described in connection with the embodiment is included in at least one embodiment of claimed subject matter. Thus, the appearances of the phrase “in one embodiment” or “an embodiment” or a “certain embodiment” in various places throughout this specification are not necessarily all referring to the same embodiment. Furthermore, the particular features, structures, or characteristics may be combined in one or more embodiments. Embodiments described herein may include machines, devices, engines, or apparatuses that operate using digital signals. Such signals may comprise electronic signals, optical signals, electromagnetic signals, or any form of energy that provides information between locations.

As mentioned previously, there may be a desire to identify information which a user may deem to be desirable or undesirable in a more efficient or cost effective manner.

Currently, for example, in an Internet context, such as on the World Wide Web, one way to gauge the desirability or undesirability of a user accessing a particular hyperlinked file, such as a web page file or other like document, may be to measure a click-through rate. A click-through rate may include a quantitative measure associated with a hyperlink, which quantifies user selective access of the hyperlink (e.g., clicking on the hyperlink through a graphical user interface). Similarly, click-through rates may also be utilized to determine a desirability associated with hyperlinks for offline applications, such as for hyperlinks in document programs, such as Microsoft Word or Microsoft Excel, as non-limiting examples. In a somewhat similar manner as suggested above, a program may determine a click-thorough rate for a particular hyperlink displayed to a user in an offline application in much the same way click-through rates may be calculated for online applications.

In addition to hyperlinks, click-through rates may also be used as a desirability metric for a particular search query. For instance, in online or offline applications, a user may begin inputting a search query and in response a search engine or other program/process may present one or more proposed search queries that the user may select instead of continuing to input their own search query A user's subsequent interaction with one or more of these hyperlinks, or additional attempts to input other search queries, may be tracked by a search engine, search program, or other application, to improve or increase the relevance of search results for that particular query for a subsequent search. Thus, drawing an analogy to click-through rates, a search engine, or other program or application, may track the frequency that a particular proposed search query leads to what a user may deem to be a desirable search result.

While click-through rates may be useful to assess a desirability of a particular hyperlink or even a proposed search query, it may be an insufficient, or less effective, measure in some instances. For example, click-through rates may sometimes indicate that particular hyperlinks, which may be spam or dead links, may be more desirable than they may otherwise be if accessed by a user. To illustrate, in a search engine context—particularly on the Internet—spammed hyperlinks may be prominently displayed (e.g., highly ranked) in a list of search results returned from a search engine or program. This may result in some users accessing this hyperlink, only to find irrelevant, less relevant or even offensive information. Interestingly, since the prominence in which a particular hyperlink may be displayed may be correlated with a click-through rate, an increase in the click-through rate may result in a particular hyperlink being displayed in a more prominent position (e.g., ranked higher) than it was previously.

Another approach that may be used to identify the desirability or undesirability of a user accessing a particular hyperlink may be to use human editors to qualitatively assess the content accessible via a particular hyperlink. In one technique, human editors may input a particular search query into a search field and access one or more hyperlinks from a list of search results that may be displayed in response to a particular search query. In this approach, human editors may qualitatively assess the content and determine, based on their judgment, or other criteria, whether the content may be desirable to a user. Thus, human editors may identify, among other things, bad or dead links, irrelevant or less relevant content, or the like. In addition, human editors may also qualitatively assess the content accessed via a hyperlink for classification purposes, such as, for example, classifying certain content as “adult” or “spam” as just an example. Of course, the technique of using human editors to identify desirable information may be costly, inefficient and—given the vast quantity of information available and being created in various digital mediums—unrealistic. Accordingly, other approaches or techniques may be desired.

With these and other concerns in mind, in accordance with certain aspects of the present description, example implementations may include methods, systems, or apparatuses for identifying a level of desirability (e.g., estimating user desirability or undesirability) of a hyperlinked file or search query using an “experience score”, at least in part. For example, in an embodiment, an experience score may be generated based, at least in part, on accessing binary digital signals relating to one or more user's interaction with one or more hyperlinks or other like user selectable features/information. In another embodiment, an experience score may be generated based, at least in part, on accessing binary digital signals relating to one or more user's inputs of one or more search queries via a search field or other like user interface. In yet another embodiment, a machine learning process may, based at least in part on its training, estimate a desirability of a hyperlink or search query using one or more experience scores, which may then be used to associate with a hyperlink or search query as part of a ranking function, for example. In certain embodiments, an experience score associated with a particular hyperlink or proposed search query may be used to adjust its relevance, aid in its classification as relating to one or more particular categories of content, or may be used for a multitude of other purposes.

As used herein, an “experience score” may be based, at least in part, on at least one of a “skip rate”, a “skip score”, or a combination thereof. For example, in certain embodiments, a “skip rate” may be expressed as a score or value to be associated with a particular hyperlink or search query, where the score or value is associated with an estimated probability that a particular hyperlink or search query may be “skipped” by a user. A particular hyperlink may be considered “skipped”, for example, if within a particular period of time after selecting the hyperlink, a user acts in some manner instead to access or select another hyperlink and/or otherwise to navigate away from the hyperlink. Thus, for example, a user may select (e.g., through a graphical user interface) a hyperlink which is operatively linked to a file thought to be of interest. However, for some reason the user's experience having selected the hyperlink becomes undesirable which leads the user to navigate away (e.g., navigate back to a previous display) from the hyperlinked file. Similarly, a particular search query may be considered “skipped”, for example, if within a particular period of time after inputting the search query, a user acts in some manner instead to input or select another search query (such as search query suggested by a browser, for example). One or more metrics, such as an experience score, may be established to estimate the potential for such a change in the level of desirability of the hyperlink for a user. An experience score may be established, for example, based at least in part on measured data, and/or estimated in some manner, such as by using a machine learning process, and/or the like.

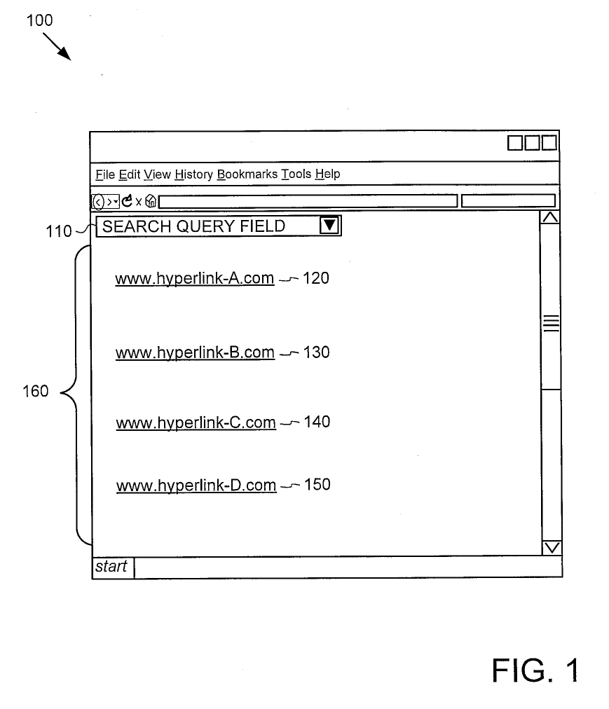

FIG. 1 may serve as a helpful illustration. Web page 100 depicts a displayed web page with exemplary search query field 110 and exemplary search results 160 thereon. In an embodiment, a user may input a search query into search query field 110 which may result in search results 160 (hyperlinks 120-150) being displayed. Here, a user may access (e.g., operatively select) a particular hyperlink, such as hyperlink 120, for example. Once accessed, a user may determine that the experience resulting from accessing hyperlink 120, may not be desirable and, as such, may selectively navigate back, or otherwise return, to web page 100. Similarly, a user may determine that the experience resulting from accessing hyperlink 120 may not be desirable and thus access another hyperlink, such as a hyperlink on displayed web page 100. A user may find the experience resulting from accessing a hyperlink undesirable because the hyperlinked file does not work properly, takes too long to render, or the content displayed may be irrelevant, as just some examples. The duration of time between a user accessing a particular hyperlink and accessing another (or otherwise navigating away), or the time between a user inputting a particular search query and inputting or selecting another, is termed herein as an “experience duration.”

In certain embodiments, to be considered a “skipped” hyperlink, an experience duration for that particular hyperlink may be lower than a threshold period of time, such as 180 seconds, for example. Thus, if a user accessed hyperlink 120 in the above example, and within 180 seconds, accessed another hyperlink, or otherwise navigated away, then hyperlink 120 may be considered skipped.

Of course, in certain embodiments, the threshold time for a particular hyperlink to be considered “skipped” may vary. For example, a longer time period may increase the number of skipped hyperlinks; whereas, a shorter time period may result in the opposite. There may be various advantages or disadvantages associated with certain experience duration thresholds, some of which will be discussed below. Suffice it to say that there may be numerous experience duration thresholds in various embodiments which may serve a variety of purposes; accordingly, claimed subject matter is not to be limited in scope to any particular experience duration threshold.

As mentioned above, an experience score may also be a “skip score.” A “skip score” may be a score or a value which reflects a composite experience duration for a particular hyperlink or search query. Accordingly, in certain embodiments, a plurality of experience durations for a particular hyperlink or a particular search query may be averaged, for example, to determine a “skip score.” Skip rate and skip score, including the various ways they may be determined, and the various factors they may include, will be explained in more detail below. Here, however, it is worth noting that there are a variety of different approaches or techniques to calculate probabilities associated with skip rates and/or composite values, such as an average associated with skip score, which may take into account many different factors. Accordingly, so as to not obscure claimed subject matter, only a few exemplary approaches or techniques will be discussed. Thus, the scope of claimed subject matter is not to be limited to these exemplary approaches or techniques.

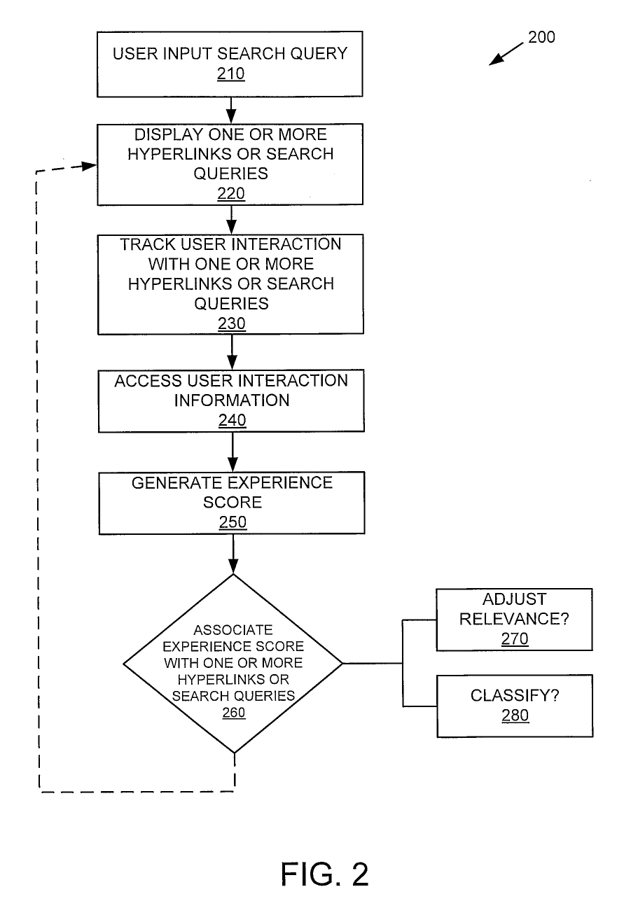

FIG. 2 is a flow chart depicting an exemplary embodiment of a method to identify a level of desirability of a hyperlink or search query using an experience score. At block 210, a user may input a search query into a search field via a graphical user interface, such as search query field 110 in FIG. 1. Here, a graphical user interface (GUI) may refer to a program interface that utilizes displayed graphical information to allow a user to control, operate, or otherwise interface with, a special purpose computing platform, for example, and/or other computing platforms, such as platforms which may be networked with a special purpose computing platform, or other devices.

At block 220, in response to a user's input of a search query at block 210, a set of search results, such as hyperlinks 160 in FIG. 1, may be displayed. Of course, in this exemplary embodiment, hyperlinks may be displayed to a user as a set of search results. In certain embodiments, however, one or more hyperlinks may exist in online or offline applications, documents, files, or the like, which may or may not be displayed to a user in response to a user request or as a set of search results. Thus, hyperlinks may be found in a documents program, on a desktop, or on a web page, as just a few non-limiting examples.

At block 230, a search engine, program, or other application or apparatus may track one or more user's interactions with one or more hyperlinks or search queries. For example, as suggested previously in the context of click-through rates, a user's interactions with a hyperlink or search query may be tracked and compiled. This information may be used in substantially real-time, and/or compiled in a database for later use or analysis. Of course, due to the various environments where hyperlinks or search query fields may be found, a wide range of applications, programs, or apparatuses may operate at the client or server level to track or compile this information, for example. A search engine, program, or other application or apparatus may track a user's interaction with a hyperlink or dynamically provided proposed search queries to compile information which may be utilized to determine an experience duration, such as tracking the period of time a user spends on a web page after accessing a particular hyperlink, for example.

At block 240, user interaction information, such as previously described at block 230, may be accessed. At block 250, based at least partially on this information, one or more processes or apparatuses may generate one or more experience scores. In general, experience scores may be generated for search queries, hyperlinks and/or, search query/hyperlink pairs. That is, in various embodiments, one or more experience scores may be generated for a search query, for a hyperlink, or for a search query/hyperlink pair. Some of these various embodiments will be discuss in more detail below; first, however, more discussion of determining skip rates and skip scores is provided.

As mentioned previously, in an embodiment, a skip rate may be associated with score or value that may reflect the probability that a particular hyperlink or search query may be skipped in the future. While there are many ways to determine a probability, one way may be to determine a probability may be to determine a ratio for the number of instances a particular hyperlink or search query has been skipped relative to the number of instances it may be accessed, selected, or inputted. For example, returning briefly to FIG. 1, hyperlink 120 may have been accessed 100 times and may have been skipped 30 of those times. In short, the experience duration was less than a threshold amount for 30 out of the 100 times hyperlink 120 has been accessed. Accordingly, hyperlink 120 may receive a 30% skip rate. Of course, the number of times a hyperlink as been accessed, or skipped, may also vary by a period of time. For example, a skip rate may be determined based on user interactions over a particular day, week, year, etc. Thus, the probability that a particular hyperlink may be skipped may be determined for any particular of time. In an embodiment, hyperlinks with a skip rate greater than or equal to 80% may generally be considered undesirable, as just an example. A skip rate may be determined for a search query in a similar manner as just described.

Likewise, in certain embodiments, hyperlinks less frequently accessed by users may be filtered out to reduce noise. For example, in an embodiment, a skip rate may not be determined for hyperlinks or search queries which may be accessed or inputted less than 60 times in a day period. One rationale behind this approach may be to spend program resources on hyperlinks or search queries which users more frequently access or input, as just an example.

Similarly, at block 250, one or more processes or apparatuses may also determine a skip score. In an embodiment, a composite experience duration for a particular hyperlink or search query may be determined. In certain embodiments, a composite experience duration may be an average value, such as a mean, median or mode value, for a plurality of experience durations over a period of time. Returning briefly to FIG. 1 to illustrate, assume hyperlink 120 has been accessed 100 times in a particular day. An experience duration for at least some, or all, of the 100 times hyperlink 120 has been accessed may be tracked or compiled. A process or apparatus may access this information and determine an average experience duration for hyperlink 120. For example, a skip score for hyperlink 120 may be 40 seconds, as just an example. In addition, similar to a skip rate, a skip score may be determined based on user interaction information for any particular period of time (e.g., an hour, a day, historically, etc). In an embodiment, hyperlinks with a skip score less than or equal to 30 seconds may be considered undesirable, as just an example.

Also, in an embodiment, in order to avoid bias, experience durations exceeding a particular quantity of time may be disregarded in connection with determining a composite value for a skip score. For example, in an embodiment, a “cutoff” value may be established, such as 180 seconds, where experience durations exceeding this cutoff value do not factor into a skip score determination. One rationale behind this approach may be that, since distributions of skip scores tend to be long tail, longer experience durations, such as experience durations exceeding 180 seconds, for example, may result in a less accurate composite value. This may not be the case, however, in other embodiments. For example, in certain embodiments, a composite value for a skip score may not disregard experience duration values. Accordingly, in these embodiments, a composite value for a skip score may factor in any or all experience durations.

Skip score and skip rate are believed to reflect a desirability of a user accessing a particular hyperlinked file or inputting a particular search query for numerous similar and/or dissimilar reasons. For example, both skip score and skip rate may be relatively effective measures of content quality or content relevance. However, it is believed that skip rate, in particular, may better reflect the presence of undesirable content, such as spam, or dead links, for example. It is also believed that skip score, in particular, may better reflect the presence of adult content, for example. Of course, these characteristics may change based on myriad factors, such as values associated with noise or bias filtering, the period of time that user interaction information was compiled or tracked, and/or the method of computation. Accordingly, the above examples or illustrations are merely exemplary and the scope of claimed subject matter is not to be limited to any particular example or illustration.

As mentioned previously, one or more experience scores may be generated for search queries, hyperlinks and/or, search query/hyperlink pairs. To illustrate, suppose a process, apparatus or system has access to the following sample data set: <Query, document/file, experience score>. Here, for sake of simplicity in this illustration, further assume that the above experience score is skip rate information. Thus, a sample data set may appear as:

query 1, hyperlink 1, skipped

query 1, hyperlink 2, not-skipped

query 2, hyperlink 3, skipped

query 2, hyperlink 3, non-skipped

In an environment where the skip score is generated with regard to a search query, the following experience scores may be generated based on the above sample data set: query 1-total 2, skipped 1=0.5 skip rate; query 2-total 2, skipped 1=0.5 skip rate. Similarly, in an environment where the skip score is generated with regard to a document/file, the following experience scores may be generated based on the above sample data set: hyperlink 1-total 1, skipped 1=1 skip rate; hyperlink 2-total 1, skipped 0=0 skip rate; hyperlink 3-total 2, skipped 1=0.5 skip rate. Next, in an environment where the skip score is generated with regard to a paring, the following experience scores may be generated based on the above sample data set: query 1, hyperlink 1-total 1, skipped 1=1 skip rate; query 1, hyperlink 2-total 1, skipped 0=0 skip rate; query 2, hyperlink 3-total 2, skipped 1=0.5 skip rate.

While skip rates and skip scores may be used to show a desirability, they may also be useful to compare a particular hyperlink, search query, or pairing with other hyperlinks, search queries, or pairings. For example, in the above illustration for a search query/hyperlink pairing, it may be seen that for query 1: hyperlink 1 is associated with a 1 skip rate and hyperlink 2 is associated with a 0 skip rate. Thus, comparing hyperlink 1 and 2 for query 1, it may be evident that hyperlink 2 is a more desirable link for query 1, since it is associated with a lower skip rate. Similarly, this comparison may also be performed for a search query. For example, assume search query 1 is associated with a skip rate of 0.5 and query 2 is associated with a skip rate of 1.0. Here, it may be evident that query 1 is more desirable than query 2 since it is associated with a lower skip rate. In an embodiment, search query comparisons such as just described may be useful in a “try also” application, where a search engine, program, or apparatus suggests particular search terms in response to a user inputting a search query.

In addition, at block 250, a composite experience score may be generated for a particular hyperlink which may factor in both a skip rate and a skip score. For example, in certain embodiments, a skip rate and a skip score may be combined, such as skip scores associated with search query/hyperlink pairs, to form a composite experience score. While there may be several approaches to combine one or more experience scores, one approach may be to use a metric produced by a linear regression technique. This approach is described in more detail below.

At block 260, an experience score may be associated with one or more particular hyperlinks or search queries. Here, associating an experience score means that an experience score may be utilized in connection with a particular hyperlink to perform a function. For example, in certain embodiments, an experience score may be associated with a particular hyperlink to adjust its relevance, to classify it as relating to a particular category of content, or for a multitude of other purposes.

To illustrate, returning again to FIG. 1, assume an experience score associated with hyperlink 140 may show that hyperlink 140 may be undesirable. In an embodiment, a search engine, program or other application, may utilize an experience score associated hyperlink 140 to adjust its relevance, such as by removing it from search results 160 or demoting it relative to search results 120, 130 or 150, for example. Similarly, an experience score associated with hyperlink 140 may show that hyperlink 140 may be desirable. Thus, hyperlink 140 may be promoted relative to search results 120 or 130, for example. Accordingly, in an embodiment, a search engine, program or other application may serve or otherwise display experience score adjusted search results, such as depicted by the dashed line in FIG. 1.

Continuing the illustration, assume an experience score associated with hyperlink 140 may show that it may relate a particular category of content. In an embodiment, a search engine, program or other application may utilize an experience score associated with hyperlink 140 to classify it as relating to one or more categories of content, such as relevant content, less relevant content, irrelevant content, adult content, spam content, or dead or non-existent link, for example.

In addition, in certain embodiments, one or more experience scores generated for a particular hyperlink may be associated with that hyperlink. In other embodiments, however, one or more experience scores generated for a particular hyperlink may be associated with one or more other hyperlinks. This may occur, for example, where an experience score generated for a particular hyperlink, such as a parent URL, may be associated with another hyperlink, such as a subordinate URL of the parent URL. This, of course, is merely an example.

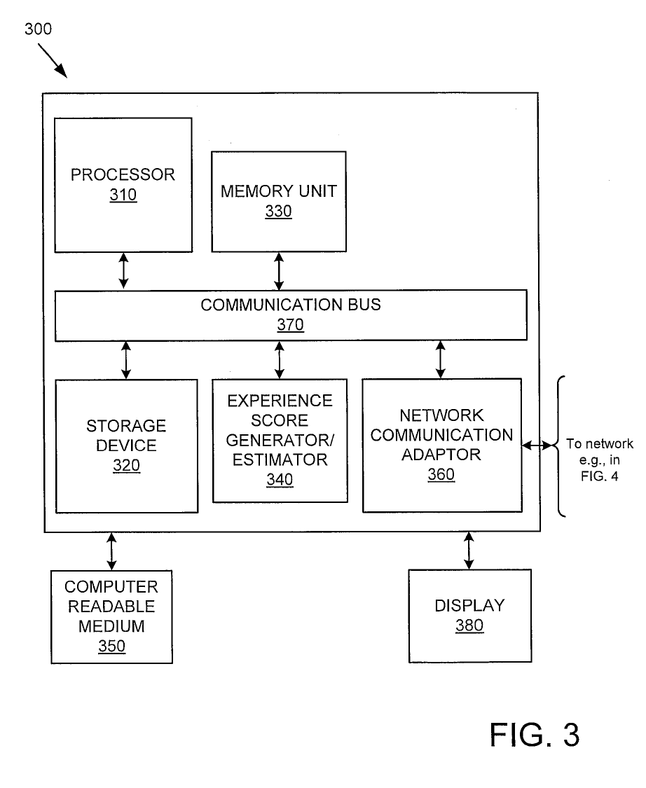

FIG. 3. a schematic diagram depicting an embodiment 300 of an apparatus to identify or estimate a desirability of a hyperlink or search query using experience score. Here, apparatus 300 may include a special purpose computing platform, such as a specific client device, and/or the like. Here, apparatus 300 depicts a special purpose computing platform that may include one or more processors, such as processor 310. Furthermore, apparatus 300 may include one or more memory devices, such as storage device 320, memory unit 330, or computer readable medium 250. In addition, apparatus 300 may include one or more network communication adapters, such as network communication adaptor 360. Apparatus 300 may also include a communication bus, such as communication bus 370, operable to allow one or more connected components to communicate under appropriate circumstances.

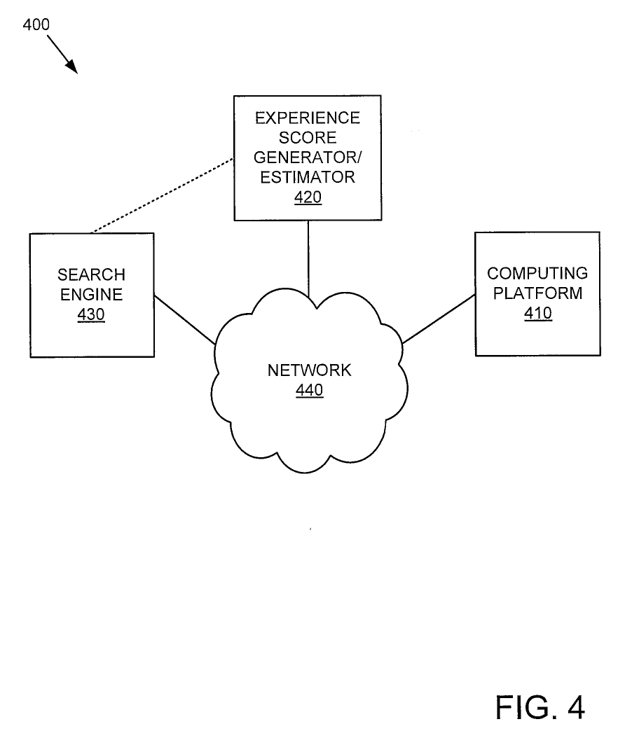

In an example embodiment, communication adapter 360 may be operable to receive or transmit signals relating to a user's interaction with one or more hyperlinks or search queries, such as by communicating with network 450 in FIG. 4, for example. In addition, as non-limiting examples, communication adapter 360 may be operable to send or receive one or more signals corresponding to an experience score for one or more hyperlinks or search queries.

In an example embodiment, experience score generator/estimator 340 may be operable to perform one or more processes previously described, such as one or more process depicted in FIG. 2. For example, experience score generator/estimator 340 may by operable to access signals relating to a user's interaction with one or more hyperlinks or search queries, generate one or more experience scores, or associate one or more experience scores with one or more hyperlinks or search queries, as non-limiting examples.

In certain embodiments, apparatus 300 may be operable to transmit or receive information relating to, or used by, one or more process or operations, such as one or more processes mention previously, via communication adapter 360, computer readable medium 350, and/or have stored some or all of such information on storage device 320, for example. As an example, computer readable medium 350 may include some form of volatile and/or nonvolatile, removable/non-removable memory, such as an optical or magnetic disk drive, a digital versatile disk, magnetic tape, flash memory, or the like. In certain embodiments, computer readable medium 350 may have stored thereon computer-readable instructions, executable code, and/or other data which may enable a computing platform to perform one or more processes or operations mentioned previously.

In certain example embodiments, apparatus 300 may be operable to store information relating to, or used by, one or more operations mentioned previously, such as signals relating to a user's interaction with one or more hyperlinks or search queries, or signals relating to one or more experience scores, in memory unit 330 and/or storage device 320. It should, however, be noted that these are merely illustrative examples and that claimed subject matter is not limited in this regard. For example, information stored or processed, or operations performed, in apparatus 300 may be performed by other components or devices depicted or not depicted in FIG. 3. To illustrate, operations which may be performed by experience score generator/estimator 340 may be performed by processor 310 in certain embodiments. Furthermore, operations performed by components or devices in apparatus 300 may be performed in distributed computing environments where one or more operations may be performed by remote processing devices which may be linked via a communication network.

In certain embodiments, apparatus 300 may be trained, such as with a machine learning process (e.g., linear regression machine learning technique) to estimate a desirability of a hyperlink or search query. For example, in an embodiment, an apparatus, or program capable of being executed by an apparatus, may be trained based at least in part on user interaction information, such as described previously; additionally or alternatively, an apparatus, or program capable of being executed by an apparatus, may be trained based at least in part on information provided by human editors. In certain instances, an apparatus, or program capable of being executed by an apparatus may estimate a desirability of a particular hyperlink or search query without accessing information provided by human editors. That is, an en embodiment, desirability judgments typically made by human editors may be made automatically based on a learned program or apparatus.

To illustrate, in an embodiment, an apparatus may first be trained on hyperlinks or search queries judged by human editors. Assume, for sake of example, that human editors reviewed a sampling of hyperlinks or search queries, say 13,000 or so, which they judged on a scale, say a desirability scale of 1-5 (with 5 being the highest). Editors may be judging pages for desirability based on some of the characteristics described previously, such as bad links, adult content, etc. In addition, assume that for at least a portion of these hyperlinks or search queries, that one or more experience scores, such as described previously, was generated. For example, in certain embodiments, an apparatus, or program capable of being executed by an apparatus may accesses a search query/hyperlink pairing with their associated skip rate, skip score and editor judgment. Here, by using a linear regression machine learning technique, for example, an apparatus or program may determine which skip scores and skip rates were associated with undesirable search query/hyperlink pairs by human editors. Thus, in certain embodiments, this linear regression may produce a metric which may be applied to search query/hyperlink pairs for which human editorial judgments may not have been made.

In an embodiment, an apparatus, or program capable of being executed by an apparatus, trained based at least in part on human editor judgments for a set of hyperlinks or search queries, such as described above, may estimated a desirability of one or more hyperlinks or search queries. There are numerous ways to do this, which may take into account many different factors or characteristics of hyperlinks or search queries. One way to do this, for example, may be based on the metric produced by the linear regression technique described previously. For example, in certain embodiments, this metric may be the following: Experience scores=−1.1384 (skip rate)+0.0057 (skip score)+2.8492. Here, desirability may be estimated by skip rate and skip score using this metric to produce a composite experience score. In addition, in an embodiment, the quantity 2.8492 may be useful to adjust an experience score into the 1-5 scale judged by human editors. In an embodiment, a composite experience score less than or equal to 2.35 may be considered undesirable, as just an example.

Alternatively, in an embodiments, where this quantity is omitted (e.g., experience score=−1.1384 (skip rate)+0.0057 (skip score)), this metric may be useful for generating composite experience scores which may be used for comparison. For example, in a search query/hyperlink pairing context, a plurality of pairings may be associated with composite experience scores. These scores may be compared as between pairs to determine which pairs are better relative to others; in general, the higher the composite experience score, the more desirable that particular pairing may be in comparisons to the other pairs. These, of course, are merely examples of ways in which a trained apparatus or program may estimate a desirability or perform a comparison.

FIG. 4. is a schematic diagram depicting an embodiment of a system to identify or estimate a desirability of a hyperlink or search query using experience score. In system 400, a computing platform 410 may be communicatively coupled to network 440. Here, in this example, computing platform 410 may be a computing platform associated with one or more users, such as a client device which may be utilized to communicatively couple to network 440. Thus, for example, a user may input a search query or access a hyperlink via a GUI that may be transmitted via computing platform 410 and network 440 to search engine 430.

System 400 may also include experience score generator/estimator 420. Experience score generator/estimator 420, which may be associated with search engine 430, for example, may be communicatively coupled to network 350. Additionally or alternatively, experience score generator/estimator 420 may be communicatively coupled directly to, or be incorporated into, search engine 430 in various embodiments. Experience score generator/estimator 420, in this example, may access signals relating to a users' interaction with one or more hyperlinks or search queries from computing platform 410, search engine 430, or from another device or programs which may be communicatively coupled to network 440. In certain embodiments, experience score generator/estimator 420 may access or have stored thereon signals relating to one or more users' interaction with one or more hyperlinks or search queries, or other information associated with experience score generation, as non-limiting examples. In addition, in certain embodiments, experience score generator/estimator 420 may access or have stored thereon signals relating to human judged hyperlinks or search queries, or other information associated with experience score generation, as non-limiting examples. Experience score generator/estimator 420 may transmit information to, or receive information from, one or more computing platforms communicatively coupled to network 440, such as computing platform 410, search engine 430, or other devices, for example.

In certain embodiments, experience score generator/estimator 420 may be operable to transmit signals via network 440 to search engine 430, or computing platform 410, which may then enable search engine 430 or computing platform 410 to perform one or more process or operations previously described, such as generating an experience score, associating an experience score with a hyperlink or search query, estimating an experience score, or performing other operations or process. For example, experience score generator/estimator 420 may transmit signals relating to one or more experience scores which may be associated with a particular hyperlink or search query. This may enable search engine 430 or computing platform 410 to perform one or more operations, such as suggest one or more search terms, adjust relevancy of one or more hyperlinks, or perform classification operations, as non-limiting examples. Accordingly, in this example, search engine 430 or computing platform 410 may be capable of storing or transmitting signals associated with one or more operations performed to other devices, such as devices which may be communicatively coupled to network 440.

Various embodiments may have a variety of advantages. For example, in an embodiment, an experience score associated with a document/file may show a desirability of that document/file and/or allow a comparison of that document/file against one or more other documents/files. This, for example, may be advantageous for classification and desirability purposes, which may increase search result success and decrease a user's search time and effort.

Similarly, another advantage of an embodiment may be that an experience score associated with a search query may show a desirability of that search query and/or allow a comparison of that search query against one or more other search queries. This may allow a search engine, for example, to construct more efficient and robust navigational query classifiers and to list improved “try also” suggestions, as just some examples.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method, comprising:
accessing binary digital signals; said binary digital signals relating to one or more user's interaction with one or more hyperlinks or search queries via a graphical user interface; and
generating at least one experience score, based, at least in part, on said binary digital signals, to be associated with said one or more hyperlinks or search queries.

2. The method of claim 1, further comprising:
associating said at least one experience score with said one or more hyperlinks or search queries, wherein said at least one experience score identifies a desirability, at least in part, of a user interacting with said one or more hyperlinks or search queries.

3. The method of claim 2, wherein said associating said at least one experience score with said one or more hyperlinks comprises identifying one or more hyperlinks as undesirable based, at least in part, on a composite experience score associated with said one or more hyperlinks.

4. The method of claim 2, wherein said associating said at least one experience score with said one or more hyperlinks comprises classifying said one or more hyperlinks as relating to one or more categories of content.

5. The method of claim 4, wherein said classifying said one or more hyperlinks as relating to one or more categories of content comprises classifying said one or more hyperlinks as at least one of the following: relevant content, less relevant content, irrelevant content, adult content, spam content, dead or non-existent link, or any combination thereof.

6. The method of claim 2, further comprising displaying said one or more hyperlinks or search queries to a user; said one or more hyperlinks or search queries being experience score adjusted hyperlinks or search queries.

7. A method comprising:
displaying on a special purpose computing platform a set of search results comprising one or more hyperlinks; said one or more hyperlinks being associated with an experience score.

8. The method of claim 7, further comprising, prior to said displaying, adjusting a relevancy of at least one hyperlink of said one or more hyperlinks in said set of search results based, at least in part, on an associated experience score.

9. The method of claim 8, wherein said adjusting a relevancy of at least one hyperlink of said one or more hyperlinks comprises promoting or demoting said at least one hyperlink in said set of set of search results based, at least in part, on an associated experience score.

10. An apparatus, comprising:
a special purpose computing platform; said computing platform further comprising:
a storage medium having instructions stored thereon; said storage medium, if said instructions are executed, further instructing said computing platform to generate at least one experience score to be associated with one or more hyperlinks or search queries.

11. The apparatus of claim 10, wherein said experience score comprises at least one of the following: a skip rate, a skip score, or a combination thereof.

12. The apparatus of claim 10, wherein said special purpose computing platform comprises a computing platform communicatively coupled to one or more databases storing, at least in part, binary digital signals relating to one or more previous users' interaction with one or more hyperlinks.

13. The apparatus of claim 10, wherein said special purpose computing platform comprises a server; wherein said server is communicatively coupled to a network of servers.

14. The apparatus of claim 13, wherein said network of servers comprises at least a part of an Internet.

15. An article comprising: a storage medium comprising instructions stored thereon which, if executed by a specific computing platform, are adapted so as to enable said specific computing platform to generate at least one experience score to be associated with one or more hyperlinks or search queries.

16. A method comprising:
estimating an experience score for one or more hyperlinks or search queries via an automated experience score estimator process;
using said experience score for said one or more hyperlinks or search queries as part of a ranking function.

17. The method of claim 16, wherein prior to said estimating, training said automated experience score estimator process, at least in part, within training information using a machine learning technique.

18. The method of claim 17, wherein said training information comprises information based, at least in part, on a set of human judged hyperlinks or information based, at least in part, on a set of human judged search queries.

19. The method of claim 17, wherein said training information comprises information based, at least in part, on experience scores previously generated for a set of hyperlinks or a set of search queries.

20. The method of claim 16, wherein said using said experience score for said one or more hyperlinks or search queries as part of a ranking function further comprises adjusting a relevancy for said one or more hyperlinks or search queries.
